(19) United States
(12) Patent Application Publication
(10) Pub. No.: US 2014/0178842 A1
(43) Pub. Date: Jun. 26, 2014

(54) GD & T LANDTM Geometric Dimensioning & Tolerancing Fundamentals Board Game

(71) Applicant: VINCENT ROBERT EARNEST, FLINT, MI (US)

(72) Inventor: VINCENT ROBERT EARNEST, FLINT, MI (US)

(21) Appl. No.: 13/913,119

(22) Filed: Jun. 7, 2013

Related U.S. Application Data
(60) Provisional application No. 61/657,047, filed on Jun. 8, 2012.

(51) Int. Cl. G09B 19/00

(52) U.S. Cl. CPC G09B 19/0069
USPC 434/129

(57) ABSTRACT

An entertainment and educational board game is disclosed which requires players to answer questions from the concepts of the ASME Geometric Dimensioning and Tolerancing (GD & T) standards, and includes a playing board, a square shaped playing course on the playing board and formed from a plurality of joined spaces, a plurality of sets of question cards with each set representing a particular ASME GD & T question category, a plurality of GD & T color coded symbol question cards with categories from the ASME GD & T standards. The players take turns in their attempts to correctly answer the questions printed on the back of the color coded symbol question cards. The particular question card selected by each player as a result of his or her playing piece landing on a respective playing space corresponding to the ASME GD & T symbol question category for that question card symbol. The ASME GD & T standards questions on the back of the color coded symbol card are read by a Bank Administrator Judge who determines if the player answered the ASME GD & T standard question correctly and collects a fine equal to the payout value listed on the card for incorrect answers or issues GD & T currency money to the player if the question is answered correctly. It is the intent of each of the participants in the game to be the player that answers the most questions correctly and subsequently earn the most GD & T currency money.

### RELATED APPLICATIONS

This application is a U.S. Non-Provisional Patent Application which claims priority to U.S. Provisional Patent Application No. 61/656,518, which is herein incorporated by reference in its entirety.

### BACKGROUND OF THE INVENTION

The present invention relates to board games, and, more particularly, pertains to an entertainment and educational board game which requires players to answer questions related to the American Society of Mechanical Engineers (ASME) design language of geometric dimensioning and tolerancing (GD & T). Despite the advent of the home computer and the popularity of electronic games, as well as, the popularity of Smartphone devices and apps, board games retain their appeal an show no signs of falling into obsolescence as have other once popular forms of entertainment, such as the drive-in movie theater. Board games pleasurably combine qualities of life in general—calculated risk taking, weighing and evaluating the odds that outcome will occur, formulating strategies to meet a variety of future occurrences, and the indeterminacy involved with a lucky roll of the dice—in the miniaturized setting of the board game. Depending on the board game chosen, the players can target and sink an opponent's battleship; amass and manipulate real estate holdings, as in the classic Monopoly board game (U.S. Pat. No. 2,026,082). Indeed the number and types of board games are limited only by the scope of human ingenuity. The prior art reveals a number of board games having varying objectives, modes of play, and goals. For example, U.S. Pat. No. 1,635,734 (Zeigler) discloses a board game which requires players to correctly answer a question drawn from various categories, and, if the question is answered correctly, the player advances on the game board squares the number indicated on the question card. The first player to reach the goal, which is a schoolhouse on the game board, is declared the winner. U.S. Pat. No. 4,090,717 (Rosetti) features a game board and a plurality of question cards, and requires the use of an encyclopedia for assisting each player in correctly answering the question cards. U.S. Pat. No. 4,487,418 (Allen Sr.) discloses a game apparatus which includes a set of circular disks rotatably mounted on a post screw. The disks comprise a base, a question disk, an answer disk, a cover disk, and also a pointer. By spinning the pointer and rotating the various disks, questions and answers are uncovered. U.S. Pat. No. 4,572,513 (Evans) discloses an educational board game wherein an audio recording contains the questions and answers. U.S. Pat. No. 5,094,465 (Dawson) discloses a shape recognition game which includes a number of clue cards arranged in a hierarchy where the simplest set of clue cards has a portion of a common object drawn thereon. The cards are graduated so that the last set of cards includes the complete object illustrated thereon. Despite the ingenuity and the pleasurable effects derived from playing the above-mentioned board games, there remains a need for a board game which is comparatively more challenging intellectually and which increases one's knowledge of the Engineering and Design world of standards.

### BRIEF SUMMARY OF THE INVENTION

The present invention comprehends an entertainment and educational board game in which a plurality of players attempt to correctly answer questions from the concepts of the ASME Geometric Dimensioning & Tolerancing Standards. The ASME GD & T standard is considered the authoritative guideline for the design language of geometric dimensioning and tolerancing (GD & T.) It establishes uniform practices for stating and interpreting GD & T and related requirements for use on engineering drawings and in related documents. GD & T is an essential tool for communicating design intent—that parts from technical drawings have the desired form, fit, function and interchangeability. By providing uniformity in drawing specifications and interpretation, GD & T reduces guesswork throughout the manufacturing process—improving quality, lowering costs, and shortening deliveries.

The entertainment and educational board game includes a playing board having a playing surface on which is illustrated a playing course that has squares which contain some of the ASME Geometric Dimensioning & Tolerancing Standard Symbols. The GD & T board game includes an answer key which is called Geometric Dimensioning and Tolerancing Fundamentals Flashcards. A Bank Judge Administrator, who is not a game participant, uses this answer key to determine if players answered questions from the GD & T symbol question cards correctly within the 120 second time limit of an hourglass sand timer. This Bank Judge Administrator resolves conflicts & collects & issues game currency money in the form of fines/fees, salaries & rewards. Players roll the dice and move a token pawn clockwise around the playing board the number of spaces indicated on the dice starting this process on the “INSPECTION PASSED” salary space. After rolling the dice, the square the player lands on has a GD & T symbol on it. The player selects the corresponding symbol card from the stack of color coded symbol cards located in the middle of the playing board surface, the player then turns over a 120 second hourglass sand timer and attempts to answer a GD & T standards question correctly, within a time limit of 120 seconds which is the duration of the hourglass sand timer time limit. The player must follow the instructions on the back of the GD & T symbol card, i.e. answer a question definition within the time period of a sand timer capsule, etc. Each player performs this process to earn money by successfully following GD & T symbol card instructions correctly. Players also earn money by collecting a salary of $500.00 each time they pass the “INSPECTION PASSED” space. Players that do not answer or follow instructions correctly are fined the specified value of the GD & T symbol card. The player with the most money at the end of the game is the winner of the game.

### FIELD OF THE INVENTION

The present invention generally relates to a board game and more specifically to an educational memorization board game covering the concepts and terminology of the ASME Y 14.5 M Geometric Dimensioning and Tolerancing Fundamentals.

### BRIEF DESCRIPTION OF THE DRAWINGS

FIG. 1 shows a top plan view of the board game with GD & T symbol spaces and diagonal color coded GD & T symbol card spaces in the center four corners for the placement of GD & T symbol question cards of the present invention.

FIG. 2 illustrates a perspective view of the board game first shown in FIG. 1;

FIG. 3 presents a top plan view of a plurality of GD & T color coded symbol cards that are used with the board game and are placed on corresponding diagonal color coded GD & T symbol card spaces in the center four corners of the game board.

FIG. 4 presents a top plan view of a plurality of GD & T color coded symbol cards that are used with the board game and are placed on corresponding diagonal color coded GD & T symbol card spaces in the center four corners of the game board.

FIG. 5 presents a bottom plan view of the backside of a plurality of GD & T color coded symbol cards that are used with the board game and are placed on corresponding diagonal color coded GD & T symbol card spaces in the center four corners of the game board. This area is where the GD & T concept topic questions and instructions are located.

FIG. 6 presents a top plan view of a plurality of GD & T currency dollars that are used to pay fines/fees, salaries and rewards with the board game.

FIG. 7 presents a perspective view of the dice, token pawn piece, and 120 second hourglass sand timer, and the front and back sides of an ASME GD & T ORIENTATION category symbol card. These components are used for game play with the GD & T board game.

### DETAILED DESCRIPTION AND BEST MODE OF IMPLEMENTATION

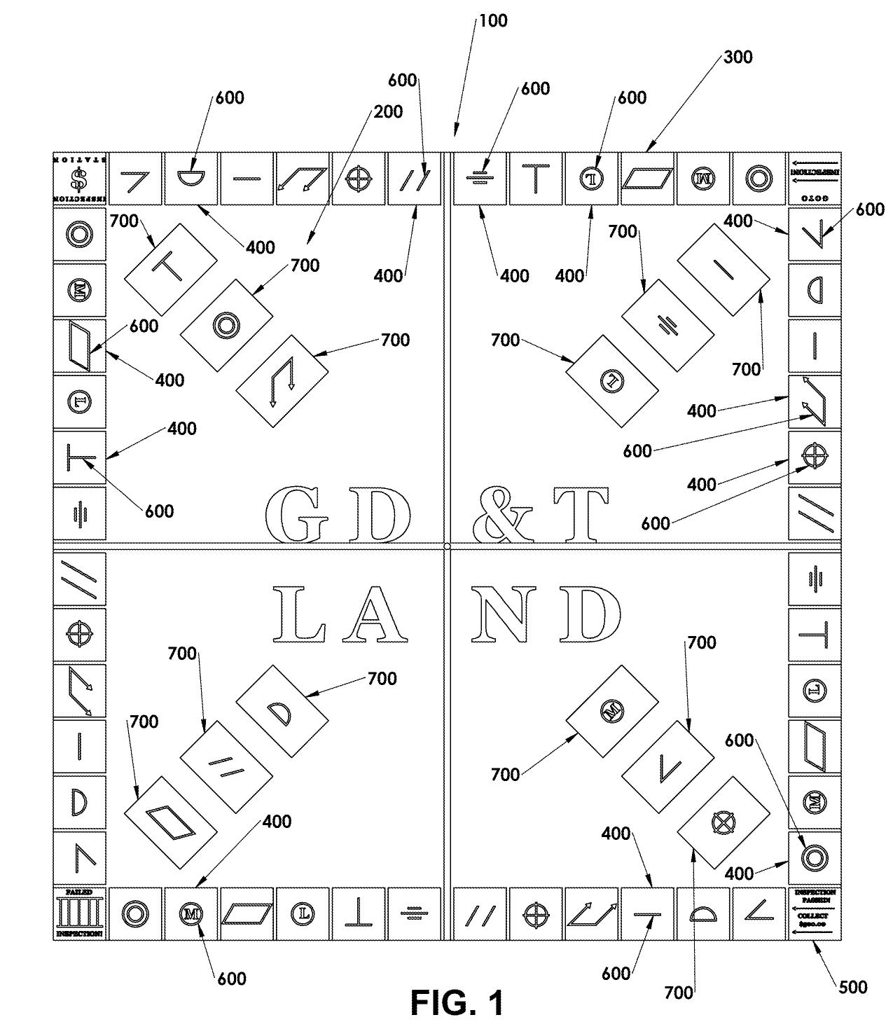

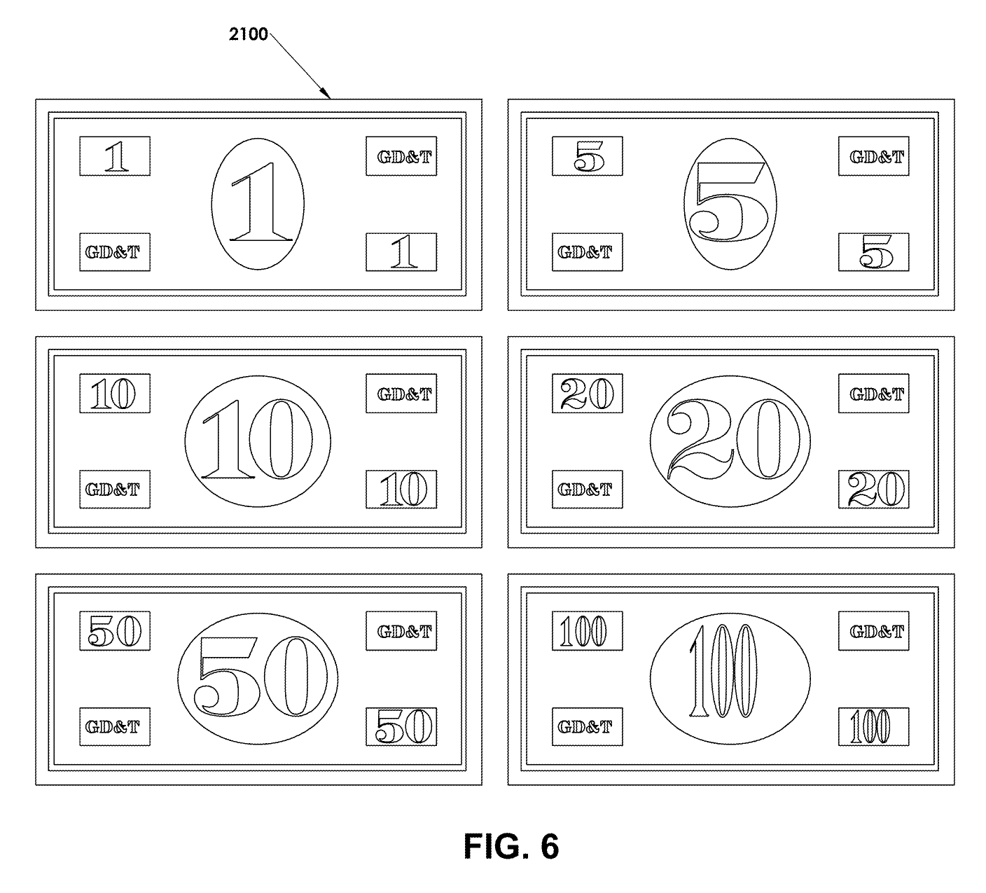

Illustrated in FIGS. 1-7 is a preferred embodiment of an entertainment and educational board game which can be played by a plurality of players, and which is designed to both provide entertainment for the players and enhance their knowledge of the ASME Geometric Dimensioning and Tolerancing (GD & T) standards.

The board game includes a foldable playing board 100 manufactured from a durable and water resistant cardboard or plastic material. The board 100 has a playing surface 200. Illustrated upon the playing surface 200 adjacent to the outer perimeter of the course 300 are playing spaces 400 that contain ASME GD & T symbols 600 which represent certain features or aspects of the board game which will be hereinafter further described.

The playing course defines the path of travel which the players take during play of the game, and the course 300 is divided into a plurality of joined playing spaces 400 each of which contains ASME GD & T symbols 600 relating to the actual play of the game and the overall theme of the game. One playing space 500 has the words “INSPECTION PASSED” contained within its borders and this INSPECTION PASSED space 500 designates the playing space on which play of the board game is to commence.

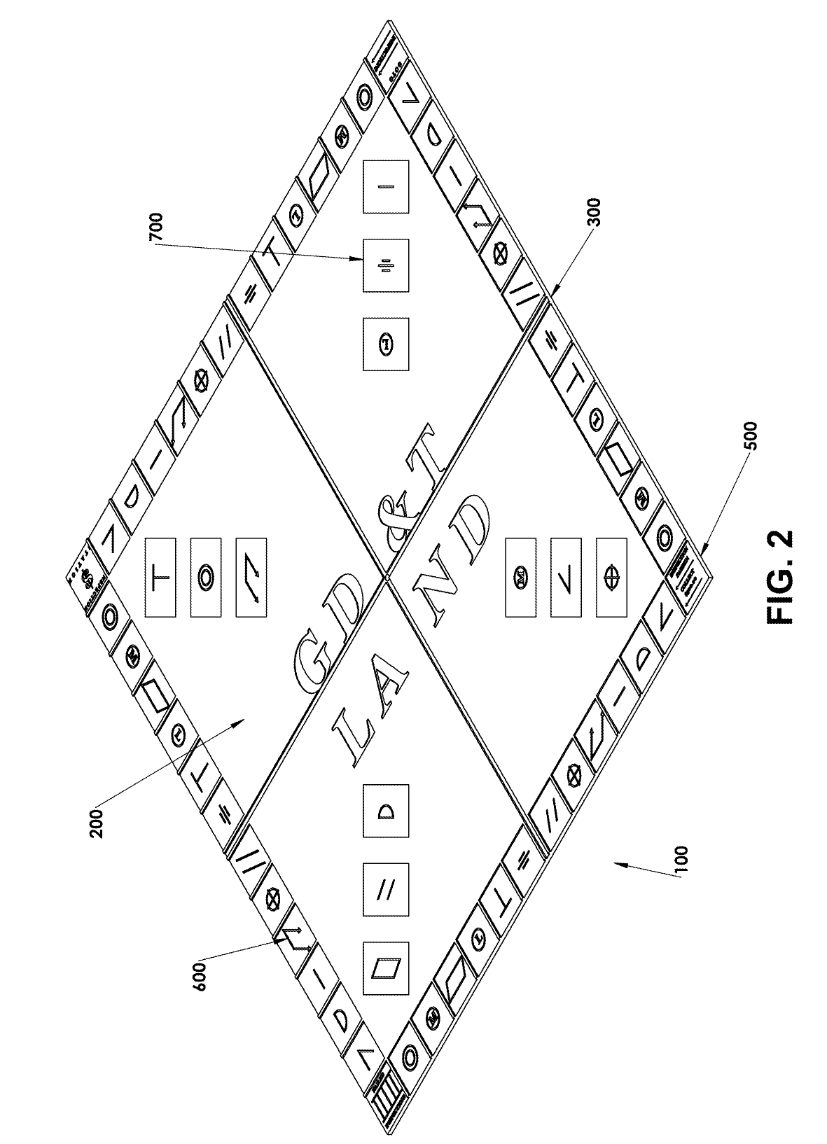

Players earn a weekly salary of $500 each time they pass this space. However, players will not collect their weekly salary if they have outstanding debts or if they have selected a GD & T symbol card which states that they cannot collect their weekly salary. As shown in FIGS. 1 and 2, a majority of the spaces 400 contain GD & T symbols 600 which denote or designate one particular question category representative of and corresponding to one question category drawn from a set of plurality of GD & T color coded symbol question categories which comprise one of the main features of the board game.

The question categories are representative of every space or realm of ASME GD & T modifying and characteristic symbols. The present board game derives questions and clues from the following ASME GD & T categories but will not exclude other categories:

From the ASME GD & T FORM category is: straightness 1100, flatness 1200.

From the ASME GD & T PROFILE category is: surface 1700.

From the ASME GD & T MODIFIERS category is: maximum material condition 2000, and least material condition 1900.

From the ASME GD & T ORIENTATION category is: angularity 1600, perpendicularity 1000, and parallelism 1300.

From the ASME GD & T LOCATION category is: position 900, concentricity 1500, and symmetry 1400.

From the ASME GD & T RUNOUT category is: total runout 1800.

In the present design of the board game, all ASME GD & T question categories are used and are illustrated in FIGS. 1 and 2. However, ASME GD & T categories which are not illustrated may be included in certain question categories of the ASME GD & T color coded symbol card categories. The question categories have been selected with the intention that anyone playing the game should at least have some familiarity with the ASME GD & T topics from the ASME GD & T symbol card question categories. To enhance the appeal and attractiveness of the game, all spaces 700 containing GD & T symbols 600 which denote one representative ASME GD & T question category will be color-coded with a distinctive color.

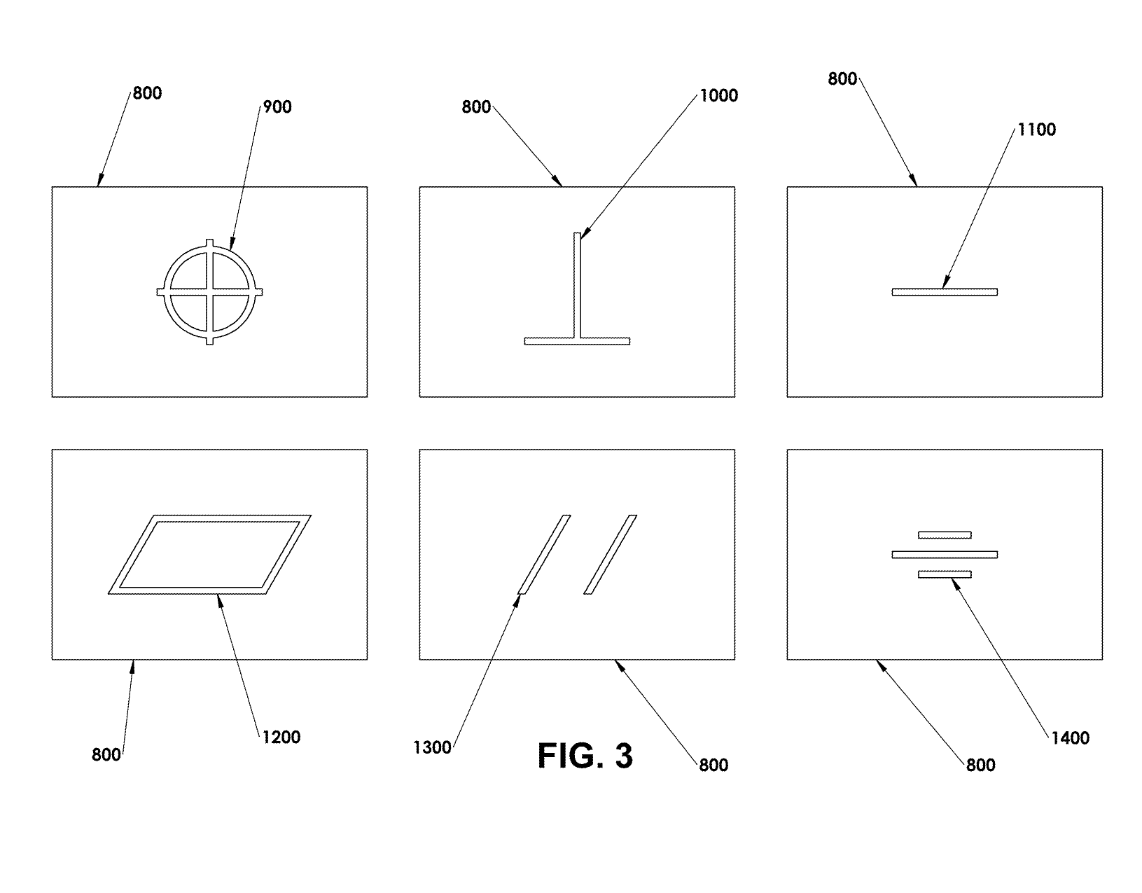

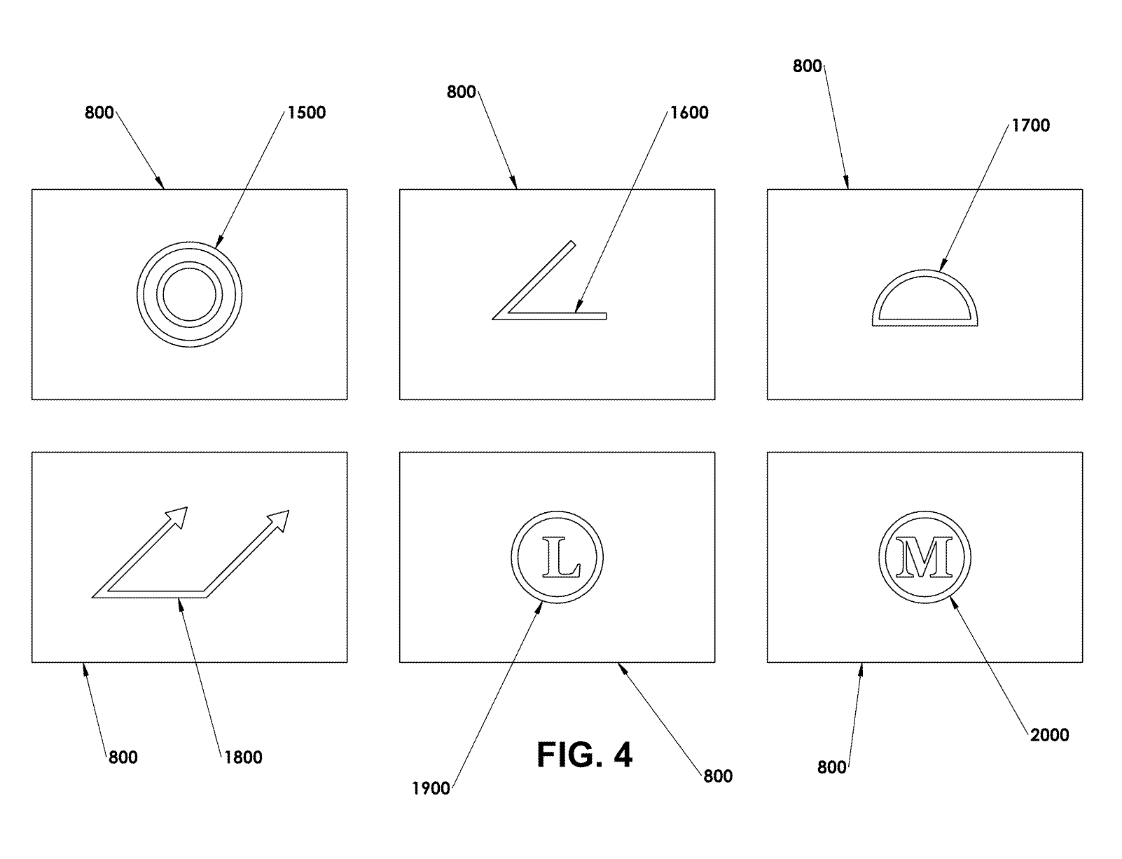

In order to physically represent each symbol question category, FIGS. 3-4 of the board game illustrate a plurality of question card sets 800. Each respective GD & T color coded symbol card set 800 corresponds to a designated GD & T color coded symbol card question category located within at least one of the spaces 700 and to one symbol category indicated on the outer perimeter of the course 300.

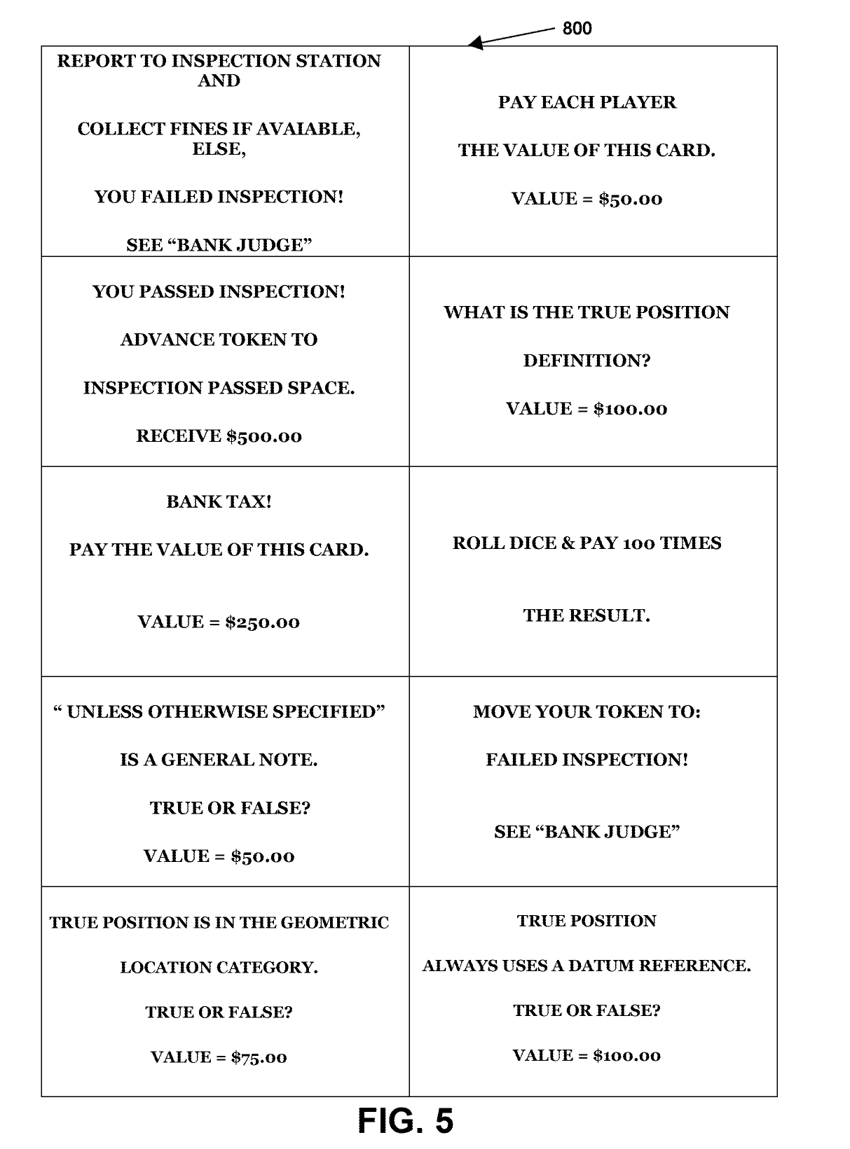

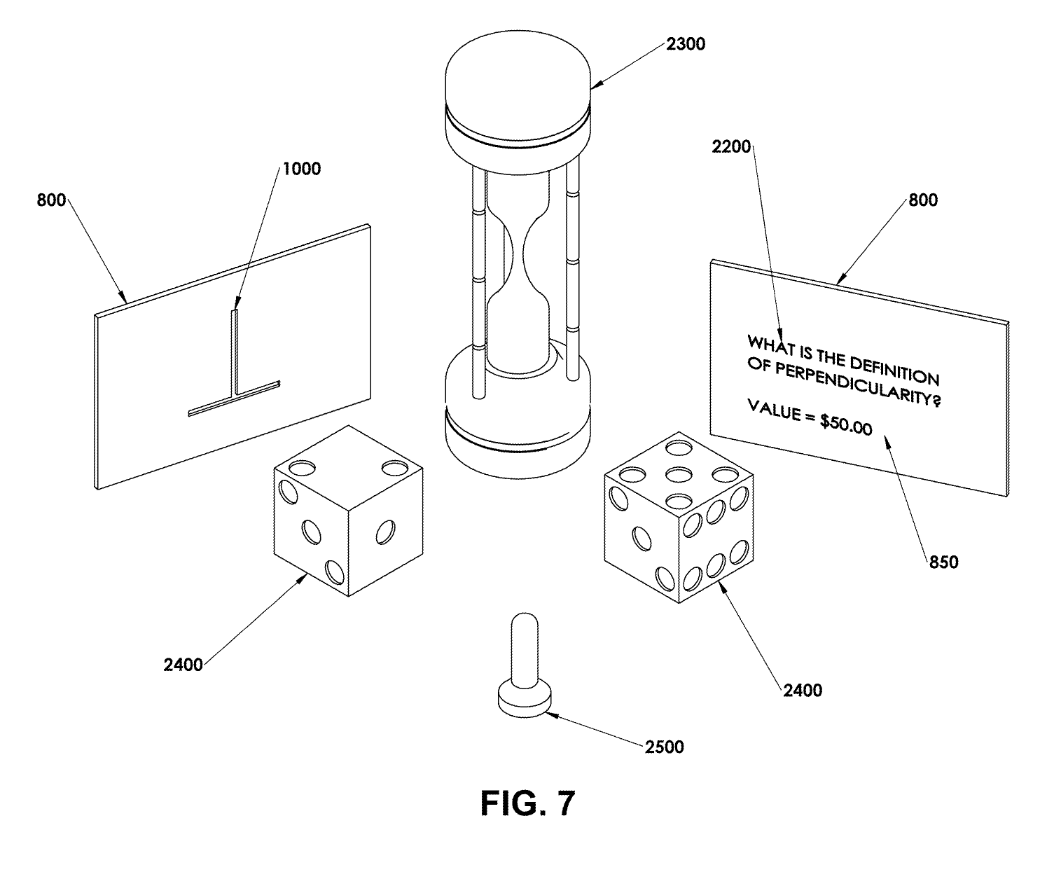

The present board game includes 12 GD & T color coded symbol card sets 800 pertaining to the ASME GD & T symbol categories: FORM, MODIFIERS, PROFILE, ORIENTATION, LOCATION, and RUNOUT. FIG. 7 illustrates a representative example of a particular color coded symbol question card from the ASME GD & T ORIENTATION symbol category. As shown in FIG. 5, statements or questions 2200 are printed on the back 850 of each GD & T symbol card 800.

In essence, all ASME GD & T color coded symbol cards have definitions and questions which are used to apply the concepts of GD & T which players use to earn GD & T currency money. If the player is unable to provide an answer within the allotted 120 second hourglass sand timer limit 2300, then that player must pay a fine equal to the payout value listed on the back of the GD & T color coded symbol card. The player with the most GD & T currency money is the winner at the end of the game when all players decide they wish to stop playing.

I claim:

1. A board game for play by a plurality of players, the educational board game comprising: a playing board having a playing surface and upon which a playing course is represented for defining a path of travel for the players; the playing course including a plurality of joined playing spaces; a majority of the playing spaces containing ASME GD & T symbols of various categories which denote a particular ASME GD & T question category representative of a plurality of question categories and at least one of four special spaces of which one playing space called “INSPECTION PASSED” also designates that playing space as the space on which play of the game is to commence; the four special spaces instruct players to perform certain tasks or instructions such as to collect or payout GD & T game currency money are located at the four corners of the game board. Players landing on any of these four corner spaces do as this space directs them; otherwise the players adhere to the instructions listed in the rules of the board game. The other spaces along the path of game play direction are embodied with ASME GD & T symbols of various GD & T standard categories. Players roll the dice to determine which GD & T category symbol they will land on. The space the player lands on has a corresponding GD & T category color coded symbol question card. After landing on the GD & T symbol space, the player selects the GD & T category symbol question card and turns over a 120 second hourglass sand timer and attempts to answer or follow the instructions on the back of the GD & T color coded symbol question card before the sand timer time limit expires. If the player successfully follows the instructions on the back of the card or answers the symbol card question correctly within the time limit period of 120 seconds, the player will earn the payout value listed on the back of the GD & T symbol card. Conversely, if the player fails to follow the instructions listed on the back of the selected card or answers the symbol card question incorrectly, or fails to complete the symbol card task within the hourglass sand timer time limit, they must pay the payout amount listed on the back of the GD & T symbol card; a plurality of GD & T symbol color coded question card sets with each GD & T symbol question card representing one particular GD & T question category corresponding to one of the GD & T symbols denoted on at least one of the playing spaces; and token pawn means for use by the players and which are disposed on the playing course for forward or backward movement thereon during play of the game.

2. A board game for play by a plurality of players, comprising: a playing board having a playing surface upon which a playing course is defined about the perimeter of a square shaped game board which also defines the path of travel for the players; the playing course including a plurality of joined playing spaces; a majority of the playing spaces containing ASME GD & T category symbols which correspond to ASME GD & T symbol color coded question cards of various ASME GD & T standard categories and at least one playing space containing instructions to collect a salary each time a player lands on or passes this space which is also the space on which the game is to commence; a plurality of ASME GD & T color coded symbol question card sets with each question card set representing one particular ASME GD & T question category corresponding to one of the question categories denoted on the majority of the playing spaces; token pawn means for disposition on the playing course so that the token pawn means can move forward or backward on the playing spaces during play of the game and the token pawn means representing the players during the game; a plurality of ASME GD & T color coded symbol question cards located in diagonal positions in the four corners of the inside playing surface of the game board.

3. A board game for play by a plurality of players, the board game comprising: a playing board having a playing surface upon which a playing course is represented in the shape of a square with ASME GD & T symbol spaces placed around the outer perimeter of the game board of which these said spaces define the path of travel for game play for the players; the playing course including a plurality of joined playing spaces; a majority of the playing spaces containing the ASME GD & T category symbols denoting a representative GD & T symbol question category selected from a plurality of GD & T color coded symbol question categories. an answer key titled Geometric Dimensioning and Tolerancing Fundamentals Flashcards used by an appointed “Bank Administrator Judge” utilized to determine if players answer ASME GD & T color coded symbol card questions and instructions correctly within a 120 second time limit of an hourglass sand timer; at least one die, the at least one die to have six sides with dots impressed into the surface of the die, with each number of impressed dots indicating the value of each individual surface of the six individual surfaces; an hourglass sand timer with a time limit duration of 120 seconds used when players answer ASME GD & T color coded symbol questions cards.
